(19) United States
(12) Patent Application Publication
(10) Pub. No.: US 2005/0262282 A1
(43) Pub. Date: Nov. 24, 2005

(54) Interrupt sharing method for edge triggering

(76) Inventor: Xue-Jun Liu, Taipei (TW)

Correspondence Address: HARNESS, DICKEY & PIERCE, P.L.C., P.O. BOX 8910, RESTON, VA, 20195, US

(21) Appl. No.: 10/849,047

(22) Filed: May 20, 2004

(51) Int. Cl. G06F 13/24

(52) U.S. Cl. 710/260

(57) ABSTRACT

An interrupt sharing method for edge triggering is disclosed. First, interrupt requests of various devices are detected before entering a main interrupt process. Various device interrupt sub-routines are called in order to process device interrupts. Finally, the device interrupt sub-routines are called in order again according to the interrupt processing results. If any interrupt is detected and processed when calling the device interrupt sub-routine in each loop, another loop of detection has to be performed. The interrupt processing exits only when non interrupt is detected in a loop. This can avoid interrupt loss or lock, realizing interrupt sharing for edge triggering.

### BACKGROUND OF THE INVENTION

1. Field of Invention

The invention relates to an interrupt sharing method and, in particular, an edge-triggering interrupt sharing method.

2. Related Art

For an interrupt request from an external device, there are two test methods: the level sensitive method and edge trigging method.

1. The Level Sensitive Method

An effective level (high or low) is detected on an interrupt request (IR) input line. The effective level can be maintained after the first interrupt sampling pulse arrives. This is considered as an IR from an external device. The corresponding bit in the interrupt status register (SR) is set to 1. The level sensitive method provides repeatedly generated interrupts for continuously executing sub-routines until the IR becomes invalid. This method allows several IR's to share the same IR input line.

2. The Edge-Triggering Method

When the IR input line is detected to have a up (down) jump from low to high (or from high to low) and the electric level remains the same until the first interrupt sampling pulse arrives, it is considered to have an IR.

However, the edge-triggering method is designed for connecting a single interrupt source. In this case, it is very difficult to have extra interrupt inputs. This is because the edge-triggering method does not support interrupt sharing, forbidding multiple interrupt sources connected to the same interrupt input line of the interrupt controller.

To solve the problem, the U.S. Pat. No. 4,631,670 disclosed a method of using hardware to implement interrupt sharing in the edge-triggering method.

### SUMMARY OF THE INVENTION

In view of the foregoing, the invention provides an interrupt sharing method for edge triggering. A software solution is used to allow multiple interrupt sources to connect to the same interrupt input line of an edge-triggering interrupt controller.

The disclosed method calls device interrupt sub-routines through multiple loops to implement the interrupt sharing for edge triggering. The procedure enters the main interrupt routine after detecting various device interrupt requests (IR's). Afterwards, the corresponding device interrupt sub-routines are called to process the device interrupts. Finally, the device interrupt sub-routines are called in order again according to the interrupt processing results.

When calling the device interrupt sub-routine in each loop, if one or several device interrupts are detected and processed, another loop of detection must be performed. The method quits the interrupt processing only when no interrupt is detected in a loop. This can avoid interrupt loss or lock, implementing interrupt sharing for edge triggering.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the hardware environment according to the invention;

FIG. 2 is a flowchart of the conventional interrupt processing program;

FIG. 3 is the interrupt loss timing diagram caused by using the conventional interrupt processing program;

FIG. 4 is the interrupt lock timing diagram caused by using the conventional interrupt processing program;

FIG. 5 is a flowchart of the disclosed interrupt sharing method;

FIG. 6 is an overall flowchart of the invention containing device interrupt sub-routines;

FIG. 7 is the timing diagram of the invention solving the interrupt loss; and

FIG. 8 is the timing diagram of the invention solving the interrupt lock.

### DETAILED DESCRIPTION OF THE INVENTION

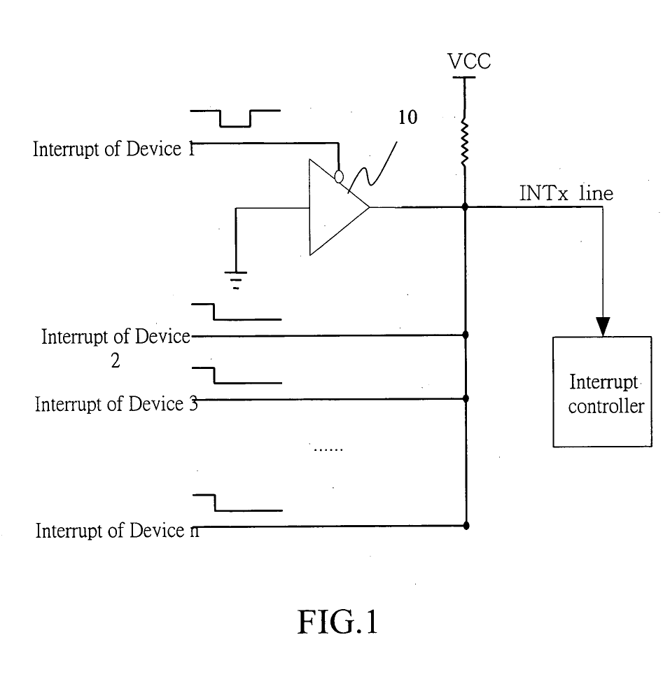

FIG. 1 shows the hardware environment of the invention. The device interrupts of Device 1 through Device n are connected in a “wired-OR” relation. As soon as any device interrupt becomes “interrupt occurring,” the interrupt state of the INTx line immediately changes to “interrupt occurring.” Then the main interrupt routine of the interrupt controller process the interrupt. Suppose the interrupt input of the interrupt controller is trigged by fall edge, the output of the interrupt source can be a pulse output or electric level output. If it is a pulse output, only the negative pulse fall edge trigging is valid. If it is an electric level output, then only the low level is valid. If the signal does not satisfy the above conditions, one can add an inverter. If the output of the interrupt source is not an open collector (OC) output, then one needs to add a tri-state buffer 10.

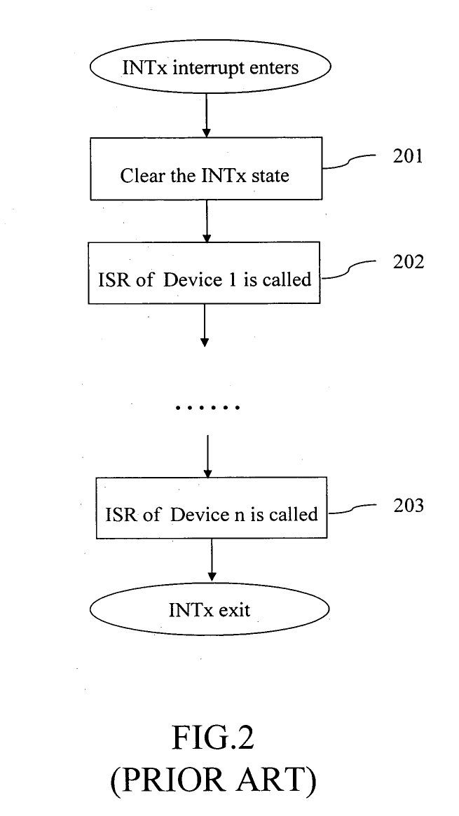

For a conventional interrupt processing program, as shown in FIG. 2, the main routine first clear the INTx state after the INTx interrupt enters (step 201). The interrupt service routine (ISR) of Device 1 is called (step 202). Such calls continue until Device n (step 203). Finally, INTx quits.

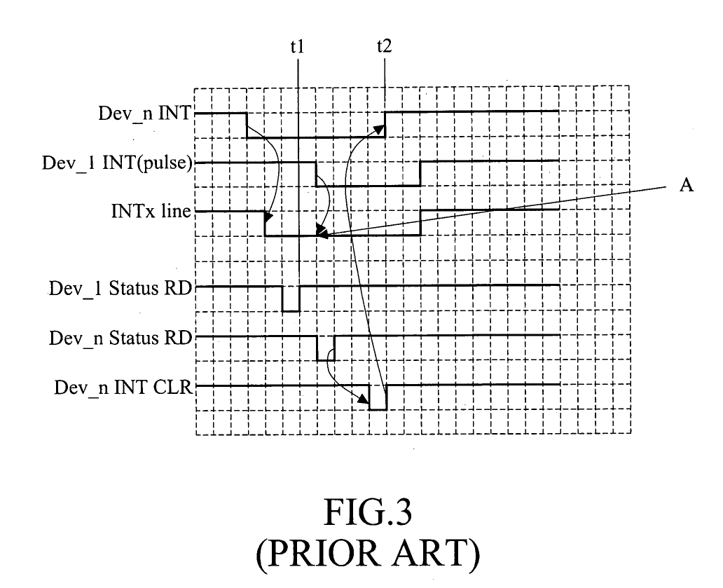

However, for the hardware connection shown in FIG. 1, there will be many problems if one uses the interrupt sharing program given in FIG. 2. With reference to FIG. 3, when the device interrupt output is a pulse output, the interrupt may be lost. Following the timing diagram, when Device n has an interrupt, a fall edge triggering main interrupt program is generated on the interrupt line. The conventional program adopts a polling mechanism. The interrupt routine of Device 1 is called at time t1. When Device 1 reads its interrupt state, it does not have any interrupt yet. When the interrupt of Device 1 occurs, the interrupt line does not produce a fall edge for the corresponding interrupt of Device 1. That is, the interrupt line remains low at point A and cannot generate a fall edge. Therefore, the main interrupt program does not process and lose this interrupt of Device 1.

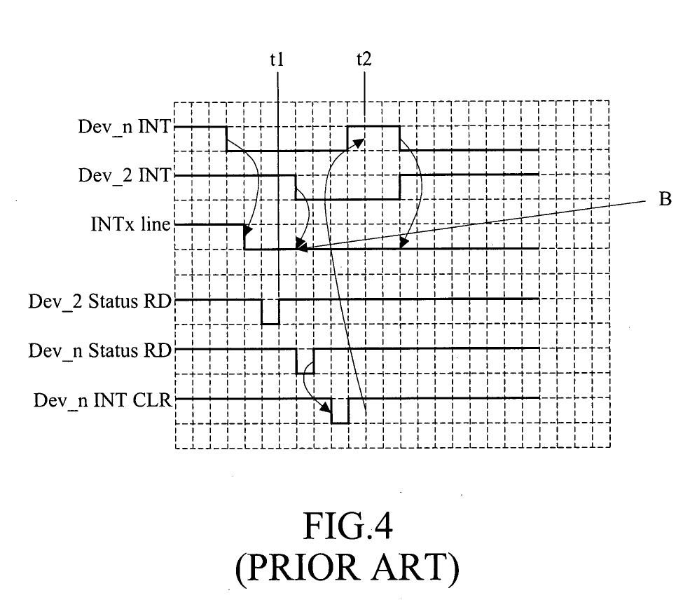

When the device interrupt output is an electric level output, the timing diagram is shown in FIG. 4. The interrupt lock will occur. With reference to the timing diagram, the interrupt line remains low at point B for the same reason; no fall edge can be generated. The interrupt of Device 2 cannot be processed. Therefore, the electric level of Device 2 interrupt output cannot be raised to high. In this case, the interrupt line is locked at low.

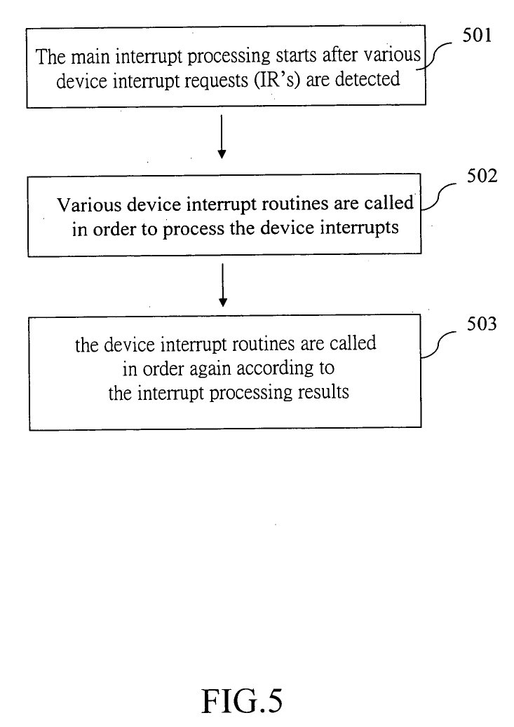

The disclosed interrupt sharing method solves the above-mentioned problems. As shown in FIG. 5, the main interrupt processing starts after various device interrupt requests (IR's) are detected (step 501). As soon as there is any device IR, the main interrupt processing starts. Various device interrupt sub-routines are called in order to process the device interrupts (step 502). Each device interrupt state is checked and the interrupt is process accordingly. Finally, the device interrupt sub-routines are called in order again according to the interrupt processing results (step 503). If any device is detected in a loop to have an interrupt, the all device interrupt sub-routines are called in the subsequent loop. The main interrupt processing exits only when no interrupt is detected at any device in a loop.

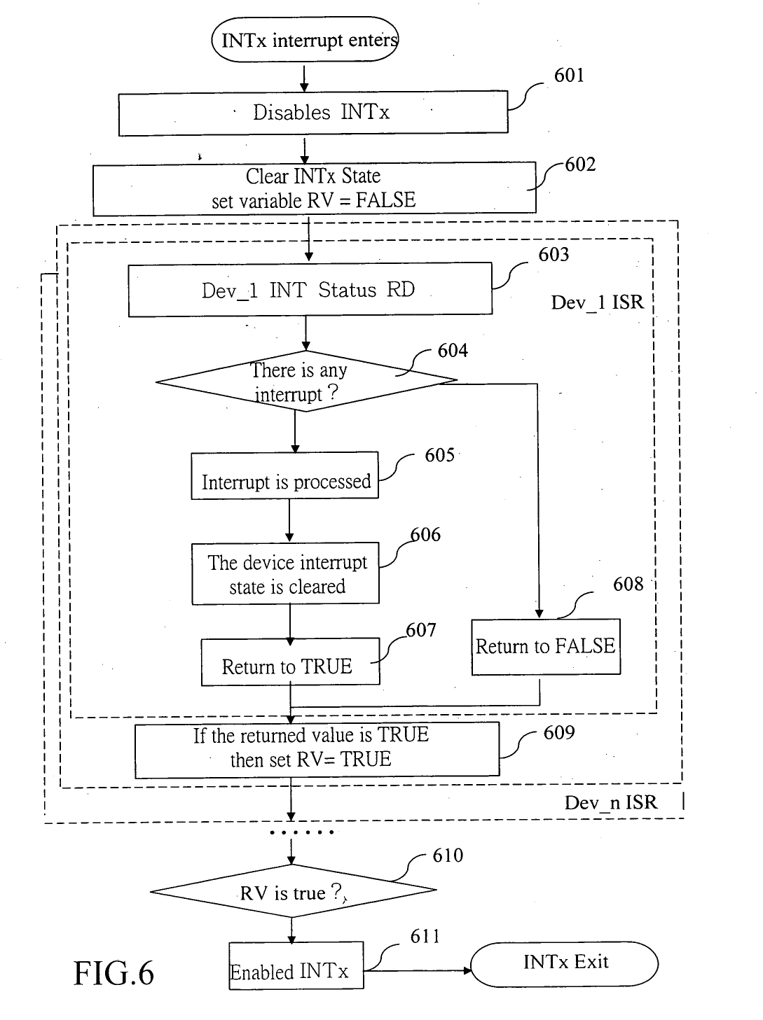

FIG. 6 shows the flowchart of the interrupt routine. After entering the interrupt process, the method first disables the main interrupt INTx (step 601). The main interrupt state (the state of the interrupt controller INTx) is cleared and the state flag variable RV of the main interrupt routine is set as false (step 602). Various device interrupt sub-routines are called in order. The method first reads the interrupt state of the device (step 603) and determines whether there is any interrupt (step 604). If there is any interrupt, it is processed (step 605). The device interrupt state is cleared, notifying the device to release the interrupt line (step 606) and process result is returned to true (step 607). If there is no interrupt, the process result is returned to false (step 608). If the returned value is true, then RV is set as true (step 609). After all devices are checked, the method further checks whether RV is true (step 610). If it is true, the procedure goes back to step 602, re-checking the interrupt devices in a new loop. Otherwise, the main interrupt line is enabled (step 611) and the method finishes.

The special point of the device interrupt sub-routine in the embodiment requires each device interrupt sub-routine to return a state value. If the device does not have any interrupt, a false value is returned. If there is any interrupt, a true value is returned. If any device returns a true value in the main interrupt program, the process flag RV is set as true. After each loop is over, the value of RV is checked. If RV is true, then another loop is started to process the interrupts of the devices. If RV is false, then the method quits the loop and the interrupt routine.

Once the checking procedure goes to Device n in the last loop and one of devices Device 1, Device 2, . . . , Device (n-1) has an interrupt, then the interrupt is not processed. The main interrupt program directly exits. However, this interrupt changes the interrupt state flag of the interrupt controller. The method immediately re-enter the main interrupt program after quitting it. Therefore, this kind of interrupt will not be lost.

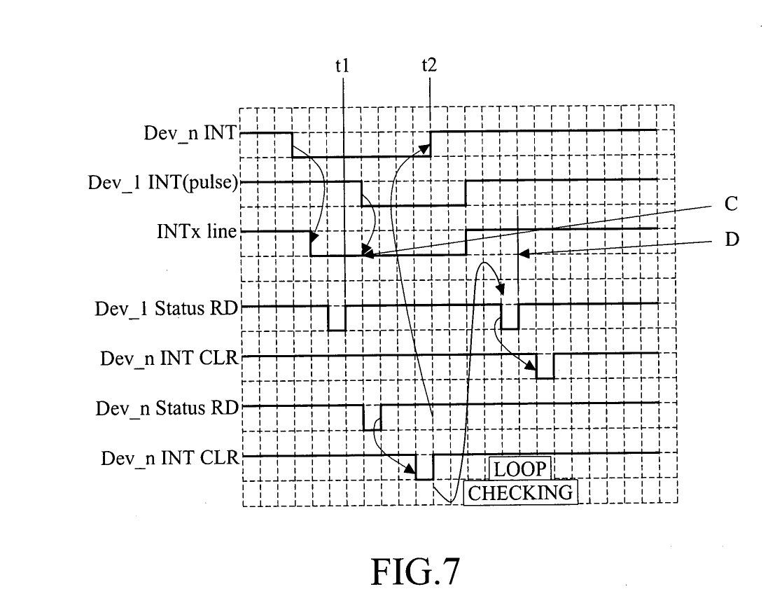

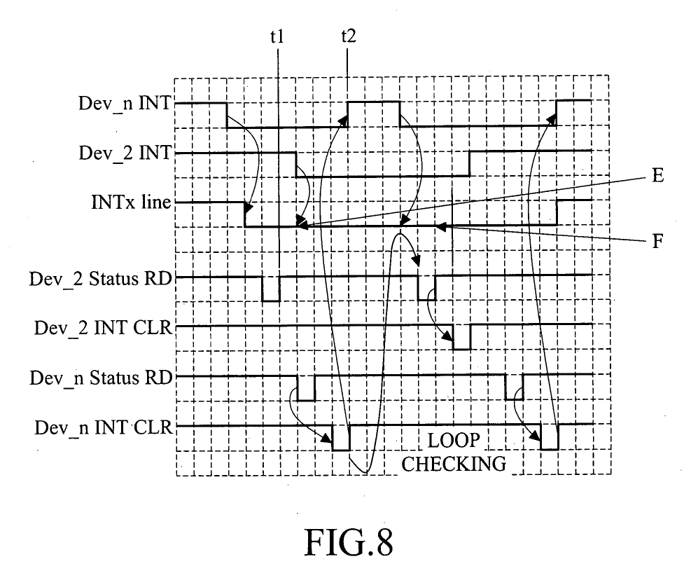

The processing details of the invention are shown in FIGS. 7 and 8. In comparison with FIGS. 2 and 3, all interrupts can be processed in the invention without loss or lock. For example, Device 1 has an interrupt at point C in FIG. 7. After the second loop checking, the interrupt of Device 1 at point D is processed. At point E in FIG. 8, Device 2 has an interrupt. After the second loop checking, the interrupt of Device 2 at point F is processed.

Certain variations would be apparent to those skilled in the art, which variations are considered within the spirit and scope of the claimed invention.

1. An interrupt sharing method for edge triggering for implementing edge-triggering interrupt sharing by making multi-loop calls of device interrupt sub-routines, the method comprising the steps of:
detecting the interrupt request (IR) of each device and entering a main interrupt process;
calling in order device interrupt sub-routines to process device interrupts; and
calling in order the device interrupt sub-routines according to the interrupt processing results.

2. The method of claim 1, wherein the step of detecting the interrupt request (IR) of each device and entering a main interrupt process is triggered by an interrupt of any device.

3. The method of claim 1, wherein the step of calling in order device interrupt sub-routines to process device interrupts checks the interrupt state of each device and processes the interrupt.

4. The method of claim 1, wherein the step of calling in order the device interrupt sub-routines according to the interrupt processing results calls all of the device interrupt sub-routines in the subsequent loop when any device has an interrupt in the current loop whereas exists the main interrupt processing when no interrupt is detected in the current loop.

5. The method of claim 1 further comprising the step of disabling a main interrupt line after the step of entering the main interrupt process.

6. The method of claim 1, wherein a state value is returned for each device interrupt processed by the device interrupt sub-routine, the state value being false if the device does not have an interrupt and true if the device has an interrupt.

7. The method of claim 6, wherein another loop of calls is processed if at least one device returns a true state value in a loop.
